(19) United States
(12) Patent Application Publication
(10) Pub. No.: US 2004/0100230 A1
(43) Pub. Date: May 27, 2004

(54) DEVICE AND A METHOD FOR CONTROL OF POWER FLOW IN A TRANSMISSION LINE

(76) Inventors: Per Halvarsson, Vasteras (SE); Mojtaba Noroozian, Vasteras (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/303,081

(22) Filed: Nov. 25, 2002

(51) Int. Cl. G05F 1/70

(52) U.S. Cl. 323/205

(57) ABSTRACT

A device (2) for control of a power flow in a three-phase ac transmission line (L2, La, Lb, Lc) has, for each of its phases (a, b, c), a transformer (12a, 12b, 12c) with a primary winding (121c) and a secondary winding (122c). The secondary winding is serially connected into the respective phase of the transmission line. A voltage dependent on a controllable part of the voltage between the other two phases of the transmission line is applied to the primary winding of the transformer. The device comprises, for each of the phases of the transmission line, a series circuit with a first (T1a, T1b, T1c) and a second (T2a, T2b, T2c) terminal and a connection point (Ja, Jb, Jc). The series circuit comprises a first reactive impedance element (21a, 21b, 21c) with a fixed reactance connected between the first terminal and the connection point, and a second reactive impedance element (22a, 22b, 22c, 23a, 23b, 23c) with a variable reactance connected between the connection point and the second terminal. One of said terminals is coupled to the respective phase of the transmission line and the other terminal is coupled to a terminal at each of the other two series circuits so that, for all the phases, either the first or the second terminal is coupled to the transmission line. The mentioned primary winding is coupled between the connection points at the other two series circuits.

### TECHNICAL FIELD

The present invention relates to a device and a method for control of power flow in a three-phase transmission line, whereby an additional voltage is serially applied to this line, for each of its phases, which additional voltage is generated in dependence on a controllable part of the voltage between the other two phases of the transmission line, and use of such a device for control of the distribution of transmitted power between parallel transmission lines and for damping of oscillations in active power between two power networks interconnected by means of a transmission line.

### BACKGROUND ART

A transmission line in this context shall mean a three-phase ac line that interconnects two electric power networks and transmits active power between the power networks.

Different kinds of devices for both static and dynamic control of the power flow in such a transmission line are known. The object of the control may be a static distribution of power between power lines or power networks, as well as damping of power oscillations in the transmission line.

One such known device is a so-called phase shifting transformer (PST). The device comprises, for each of the phases of the transmission line, a series transformer, the secondary winding of which is connected into the phase conductor, and a shunt transformer, the primary winding of which is connected between the other two phase conductors. The secondary winding of the shunt transformer is provided with an on-load tap changer and its secondary voltage, which is thus variable, is applied to the primary winding of the series transformer. The additional voltage which arises across the series transformer, and which is thus a series voltage vectorially added to the voltage of the phase conductor, attains, by this connection, a phase position that is displaced by 90° relative to the phase voltage of the phase conductor. By varying the amplitude of the additional voltage by means of the on-load tap changer, the power flow in the transmission line is influenced.

Such a phase-shifting transformer will be further described in the following.

As an alternative to the on-load tap changer, the secondary voltage of the shunt transformer may be applied to converter equipment, suitable for the purpose, for electronic control of the amplitude of the secondary voltage, for example by phase-angle control.

The on-load tap changer constitutes a mechanical component that requires maintenance and is subjected to wear. Further, it is relatively slow, the time for a change of the amplitude of the additional voltage being of the order of magnitude of seconds.

Electronic control of the amplitude of the additional voltage may be made faster but, because of its principle of operation, it injects harmonics in the transmission line.

Another such known device is a so-called universal power flow controller (UPFC). A three-phase transformer is connected in shunt connection to the transmission line and the secondary voltage of the transformer is applied to a first three-phase converter of the type pulse-width-modulated, self-commutated voltage-source converter. A second converter of the same kind is connected, by means of a dc voltage intermediate link with a capacitor, to the first converter and the second converter is connected, via its ac terminals, to series transformers connected to the transmission line. As is known, the output voltage of the second converter allows itself to be controlled both with respect to amplitude and phase angle, and may thus be used for a fast and continuous control of both active and reactive power.

The amount of power electronics is, however, relative extensive and complicated and this type of controller is therefore less attractive. Further, it exhibits sensitivity to short-circuit currents and is inclined to apply harmonic and low-frequency harmonics to the transmission line, as well as harmonics associated with the carrier frequency of the pulse-width modulation.

### SUMMARY OF THE INVENTION

The object of the invention is to provide a device and a method of the kind described in the introduction, which, in relation to the prior art, constitute an improvement with respect to the above-mentioned drawbacks.

According to the invention, this is achieved by coupling, for each of the phases of the transmission line, to the respective phase, a series circuit with a first and a second terminal and a connection point, the series circuit comprising a first reactive impedance element with a fixed reactance connected between the first terminal and the connection point, and a second reactive impedance element with controllable reactance connected between the connection point and the second terminal, whereby one of said terminals is coupled to the respective phase in the transmission line and the other terminal is coupled to a terminal at each of the other two series circuits such that, for all the phases, either the first or the second terminal is coupled to the transmission line, that the additional voltage is formed in dependence on the voltage between the connection points at the other two series circuits, and that the control of the power flow is performed by varying the reactance of the second impedance element.

In an advantageous further development of the invention, the second impedance element comprises a series circuit of one inductive and one capacitive reactance element so dimensioned in relation to each other that the phase position of the additional voltage may be varied to lie both before and after the phase position for the voltage of the transmission line in the respective phase, such that the active power flow in the transmission line may be influenced both in an increasing and a decreasing direction.

In another advantageous further development of the invention, the first impedance element comprises a first fixed inductor and the second impedance element comprises a cross-magnetized inductor with a magnetic core, a main winding for alternating current, and a control winding for direct current, the reactance of the second impedance element being varied by controlling a magnetic flux associated with the main winding by orthogonal magnetization of the magnetic flux in dependence on a direct current applied to the control winding.

In still another advantageous further development of the invention, the first reactive impedance element comprises a first fixed inductor, and the second impedance element comprises inductor equipment with a number of mutually series-connected fixed second inductors, each one of these being parallel-connected to a controllable short-circuit device, the reactance of the second impedance element being varied by respectively activating and deactivating the short-circuit devices.

Additional advantageous further developments of the invention will be clear from the following description and the appended claims.

With a device according to the invention, the following advantages are achieved, inter alia.

Shunt inductors already present in the transmission line may be utilized as a component in the device.

No mechanically movable parts, nor any converter equipment with continuous control are required.

The device does not apply any harmonics to the transmission line.

The device may also be utilized as a shunt inductor to absorb reactive power when control of power flow is of secondary interest.

Since a device according to the invention introduces additional impedance in the power network, both by the series transformer in the transmission line and by the equivalent impedance for the fixed and the controllable inductor, respectively, the short-circuit current in the transmission line is generally reduced.

### BRIEF DESCRIPTION OF THE DRAWINGS

The invention will be described in greater detail by description of embodiments with reference to the accompanying drawings, wherein

FIG. 1A shows one phase of a phase-shifting transformer according to the prior art,

FIG. 1B shows vector diagrams for the voltages of a phase-shifting transformer according to FIG. 1A,

FIG. 2 shows one phase of an embodiment of the device according to the invention,

FIG. 3A shows three phases of an embodiment of a device according to the invention,

FIG. 3B shows vector diagrams for the voltages of an embodiment of the invention according to FIG. 3A,

FIG. 4A shows three phases of a further embodiment of a device according to the invention,

FIG. 4B shows three vector diagrams for the voltages of an embodiment of the invention according to FIG. 4A, and

FIG. 5 shows a use of a device according to the invention.

### DESCRIPTION OF THE PREFERRED EMBODIMENTS

The following description relates to the method, the device as well as the use of the device.

Throughout the description the same reference numerals are used in the various figures for those parts of the device, and for quantities occurring in the device, which are of the same kind.

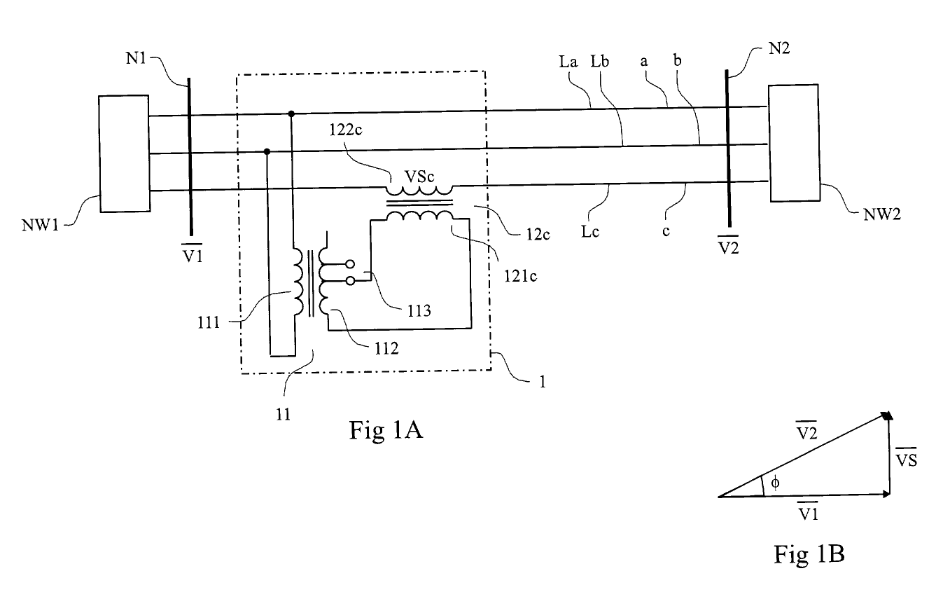

FIG. 1A shows a first power network NW1, connected to a second power network NW2 via a three-phase transmission line with the phase conductors La, Lb and Lc. The three phases are designated a, b and c.

A prior art phase-shifting transformer (PST) 1 is connected to the transmission line between two nodes N1 and N2. The voltage of the transmission line at the node N1 is designated V1 in vector form, the components of the vector consist of the phase voltages Va, Vb and Vc of the node. Analogously, the voltage at the node 2 is designated V2.

For simplicity, the figure only shows that part of the transformer that belongs to the phase c. The phase-shifting transformer comprises a shunt transformer 11, the primary winding 111 of which is connected between the phase conductors La and Lb in the transmission line. The secondary winding 112 of the shunt transformer is provided with an on-load tap changer 113, only roughly indicated in the figure. A series transformer 12c has a secondary winding 122c connected into the phase conductor Lc and its primary winding 121c is connected to the secondary winding of the shunt transformer between a terminal on the on-load tap changer of the shunt transformer and an end terminal on the secondary winding. The additional voltage VSc occurring across the series transformer attains, by this connection, a phase position that is displaced by 90° relative to the phase voltage Vc. The position of the on-load tap changer may be changed in dependence on a control signal (not shown in the figure), and the voltage applied to the primary winding of the series transformer, and hence the amplitude for the additional voltage VSc, are thus dependent on a controllable part of the voltage between the phases a and b. Although not shown in the figure, it should, of course, be understood that a series transformer of the same kind as the series transformer 12c is connected to each of the other two phases of the transmission line and that a voltage is applied thereto in an analogous manner.

FIG. 1B shows in vector form the relationship between the node voltages V1, V2 and VS, where thus the voltage VS has components VSa, VSb and VSc, where VSa and VSb thus represent additional voltages occurring across the series transformers (not shown). The phase-shifting transformer thus achieves a phase shift, in FIG. 1B designated Φ, between the voltages in the nodes 1 and 2. The flow of active power P between the nodes is determined, as is known, besides by the node voltages and the impedance of the transmission line between the nodes, by the factor sin φ and may thus be influenced by changing the position of the on-load tap changer.

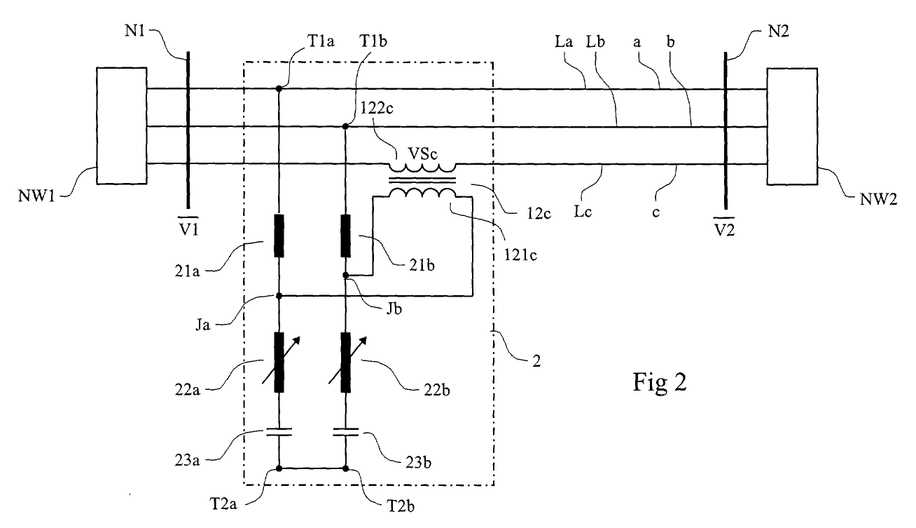

FIG. 2 shows an embodiment of a device according to the invention. In the same way as for the known device according to FIG. 1A, for the sake of simplicity FIG. 2 only shows that part of the device that belongs to the phase c. Compared with the known device described with reference to FIG. 1A, the shunt transformer with its on-load tap changer have been replaced by other components, which will be described in greater detail below.

A series circuit formed from reactive impedance elements comprises a first reactive impedance element with a fixed reactance in the form of a fixed inductor 21a and a second reactive impedance element with a variable reactance in the form of a controllable inductor 22a and a capacitor 23a connected in series. The first impedance element is connected between a first terminal T1 at the series circuit and a connection point Ja belonging to the series circuit. The second impedance element is connected between the connection point Ja and a second terminal T2a at the series circuit. The first terminal T1a is coupled to the phase conductor La of the transmission line.

A series circuit of the same kind as that described above comprises a fixed inductor 21b, a controllable inductor 22b, and a capacitor 23b. This series circuit has a first terminal T1b, a second terminal T2b, and a common connection point Jb. The inductors 21b, 22b, and the capacitor 23b are interconnected and connected to the terminals and the connection point in a manner analogous to that described above. The first terminal T1b of the series circuit is coupled to the phase conductor Lb and the two terminals T2a and T2b are mutually coupled to each other.

As in the device described with reference to FIG. 1A, the series transformer 12c is connected with its secondary winding 122c into the phase conductor Lc, whereas its primary winding 121c is coupled between the connection points Ja and Jb.

It is realized that a device of the above kind achieves a phase shift between the node voltages V1 and V2 in a manner similar to that described with reference to FIG. 1A. The flow of active power P between the nodes is thus also determined, in this device, besides by the node voltages and the impedance of the transmission line between the nodes, by the factor sin Φ, which in turn, as is easily realized, is dependent on the voltage between the connection points Ja and Jb.

This voltage, in turn, obviously depends on the relationships between the reactances of the first and second impedance elements, that is, the flow of active power between the nodes N1 and N2 is influenced when the reactance for the second impedance element is varied. The relative influence from the second impedance element increases with increasing transmitted power in the transmission line.

The controllable inductor comprised in the second impedance element achieves a voltage component VSc with a phase position in relation to the phase position of the phase voltage of the transmission line such that the power flow in the transmission line from the node N1 to the node N2 is influenced in a decreasing direction. The capacitor comprised in the second impedance element achieves a voltage component VSc with a phase position in relation to the phase position for the phase voltage of the transmission line such that the power flow in the transmission line from the node N1 to the node N2 is influenced in an increasing direction.

By a suitable dimensioning of the reactances for the controllable inductor and capacitor in relation to each other, the phase position for the additional voltage VSc may be caused to vary to be both before and behind the phase position for the phase voltage V1c of the transmission line by variation of the reactance for the controllable inductor. In this way, thus, controllability is obtained in both directions for the active power flow in the transmission line such that the active power flow in the transmission line may be influenced both in an increasing and a decreasing direction.

The controllable inductor comprised in the second impedance element may, in an advantageous embodiment of the invention, be constituted by an inductor controllable by means of so-called cross magnetization. Such an inductor has a magnetic core with a main winding for alternating current and is, in addition thereto, provided with a control winding for direct current. By varying a direct current supplied to the control winding, the magnetic flux associated with the main winding is influenced by orthogonal magnetization of the magnetic core. Such a cross-magnetized inductor is known, for example, from U.S. Pat. No. 4,393,157.

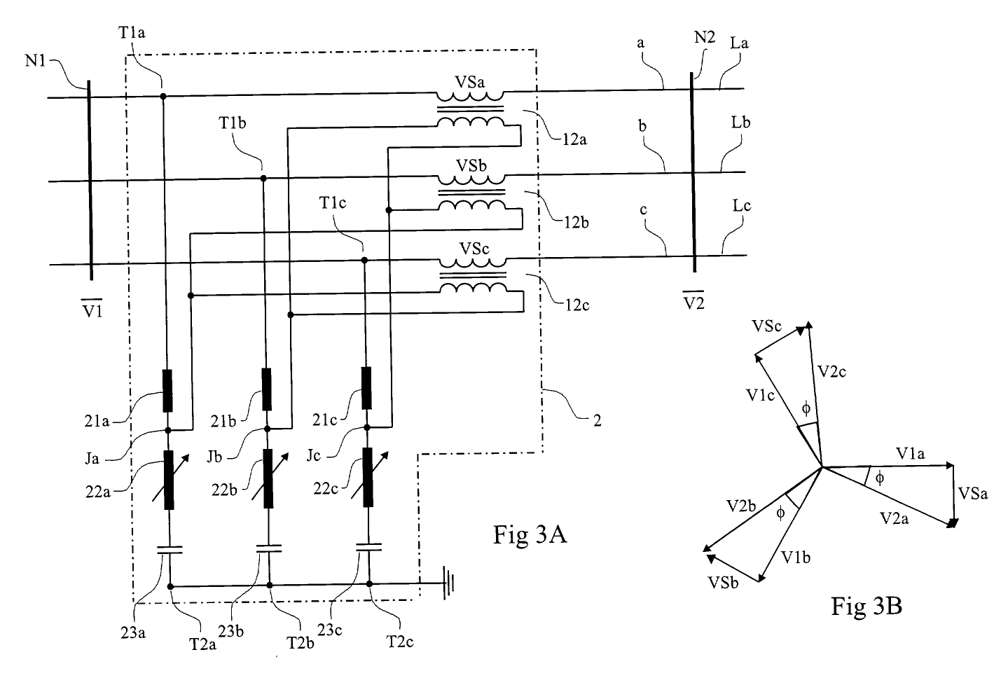

FIG. 3A shows the embodiment according to FIG. 2 with all of the three phases illustrated. A series transformer 12a has a secondary winding connected into the phase conductor La, and a series transformer 12b has a secondary winding connected into the phase conductor Lb. An additional voltage VSa arises across the series transformer 12a, and an additional voltage VSb arises across the series transformer 12b.

A series circuit of the same kind as those described with reference to FIG. 2 comprises a fixed inductor 21c, a controllable inductor 22c, and a capacitor 23c. This series circuit has a first terminal T1c, a second terminal T2c, and a common connection point Jc. The inductors 21c and 22c and the capacitor 23c are connected to each other and to the terminals and the connection point in a manner analogous to that described above. The first terminal T1c of the series circuit is coupled to the phase conductor Lc and the terminals T2a, T2b and T2c are mutually coupled to each other and shown in the figure as coupled to ground potential.

The series transformers 12a and 12b are connected with their secondary windings into the respective phase conductors La and L. The secondary winding of the series transformer 12a is coupled between the connection points Jb and Jc, whereas the secondary winding of the series transformer 12b is coupled between the connection points Ja and Jc.

FIG. 3B shows in vector form the relationship between the node voltages V1, V2 and the additional voltage VS, where thus the voltage V1 has the components V1a, V1b and V1c, the voltage V2 has the components V2a, V2b and V2c. VS has the components VSa, VSb and VSc.

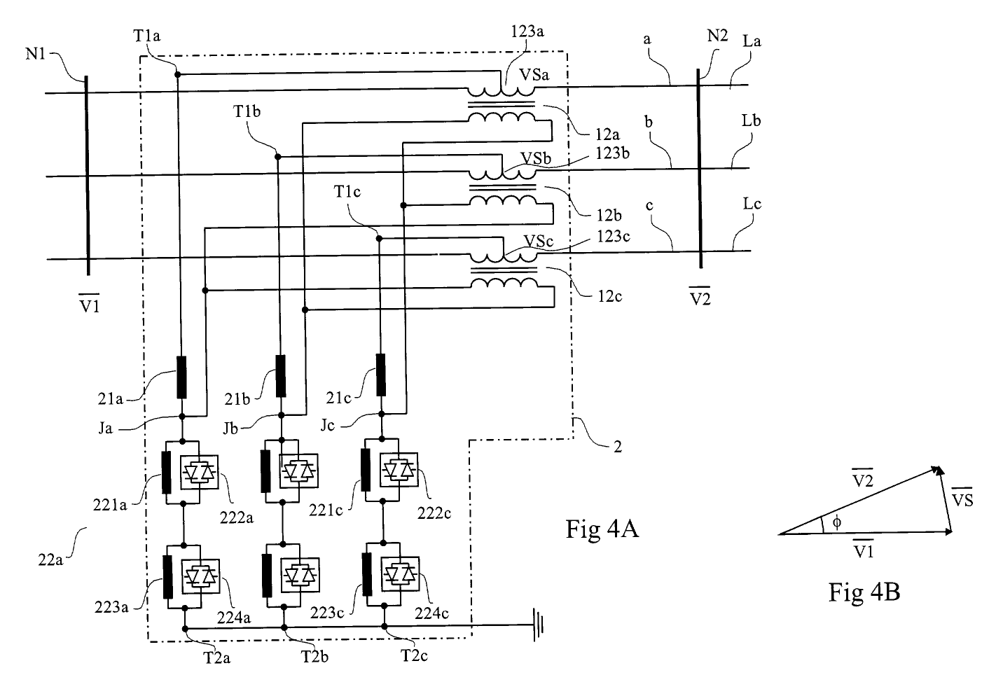

FIG. 4A shows a further embodiment of a device according to the invention. Contrary to the embodiment described in connection with FIG. 3A, the respective first terminals T1a, T1b and T1c of the series circuits, in this embodiment, are connected to centre taps 123a, 123b and 123c on the primary windings of the respective series transformer. Further, for the phase a, the second impedance element 22a comprises inductor equipment with a number of mutually series-connected fixed inductors, which for reasons of space are only shown as two inductors 221a and 223a in the figure. Each one of the fixed inductors 221a and 223a may be bypassed by means of a controllable short-circuit device, in the figure illustrated as a thyristor switch 222a and 224a, respectively, which may be influenced by a control signal (not shown). The respective second impedance elements for the phases b and c are designed in an analogous manner and comprise, for the phase b, fixed inductors 221b and 223b (the designations being omitted in the figure to render it more readily readable) with thyristor switches 222b and 224, respectively, and, for the phase c, fixed inductors 221c and 223c with thyristor switches 222c and 224c, respectively.

For reasons of space, only two series-connected fixed inductors per phase are shown in the figure, but the number may, of course, be advantageously increased to increase the possibilities of control of the reactance of the second impedance element. Preferably, the inductance values for the inductors 221a, 223a, . . . are chosen according to a geometrical scale to further increase the possibilities of variation of the reactance of the second impedance element.

FIG. 4B shows in vector form the relationship between the node voltages V1, V2 and the additional voltage VS in this embodiment of the invention. By connecting the respective first terminals T1a, T1b and T1c of the series circuits to the centre taps 123a, 123b and 123c on the primary windings of the series transformers, the advantage is achieved, contrary to the embodiment described with reference to FIG. 3, that the node voltage V2 will have the same amplitude as the node voltage V1.

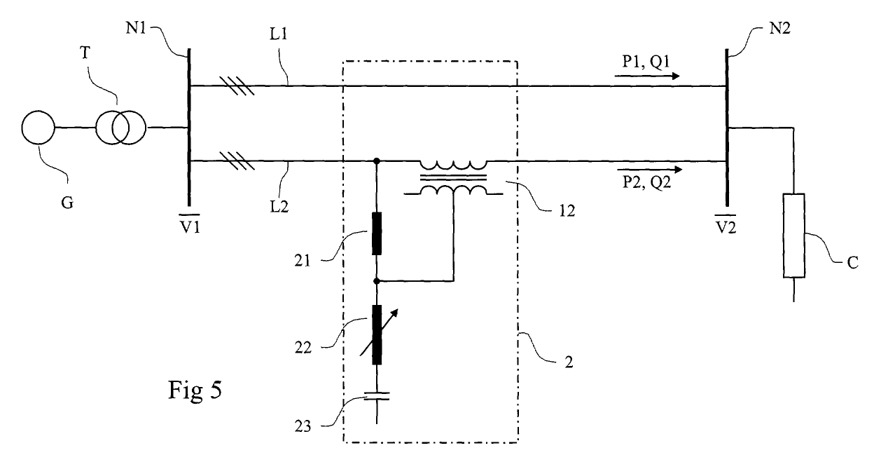

FIG. 5 shows a use of a device according to the invention. Two three-phase transmission lines L1 and L2 connect nodes N1 and N2. Node N1 is supplied, via a transformer T, with power from a generator G. To node N2, a load C is connected. Of the power supplied to node N1, one part P1 is distributed on the transmission line L1 and one part P2 is distributed on the transmission line L2. The nominal voltage of the transmission lines is 400 kV.

A device 2 according to the invention is coupled to the transmission line L2. The device is illustrated in a simplified single-line diagram, but it is to be understood that it is designed, for example, in the manner described with reference to FIG. 3A. The first reactive impedance element with a fixed reactance thus comprises an inductor 21, and the second reactive impedance element comprises an inductor 22 with a variable reactance and, in series connection therewith, a fixed capacitor 23.

In a practical embodiment, the load C consumes an active power of 600 MW and a reactive power of 150 MVAr, that is, P1+P2=600 MW.

The series transformer 12 has a rated power of 135 MVA, a transformation ratio of 60/60 kV, and a short-circuit reactance of 10%.

The fixed inductor 21 has a rated power of 120 MVAr at 400 kV, corresponding to a reactance of 1 333 ohms. The reactor 22 has a reactance that is variable in the interval of 30-150 ohms whereas the capacitor 23 has a fixed reactance of ohms. The reactance of the second reactive impedance element may thus in this case be varied from −30 ohms to +90 ohms.

Studies have shown that the power P2 can be controlled from 150 MW to 450 MW when the reactance of the second impedance element is varied from −30 ohm to +90 ohms. The voltage across the second reactive impedance element thereby varies within the interval of 46-56 kV whereas the current through the impedance element varies within the interval 1.14-0.25 kA.

The control of the reactance of the second impedance element occurs in some manner known to the person skilled in the art by supplying a deviation between a sensed value of active power in the transmission line and a reference value thereof to a controller, whereby a reference value for desired reactance is formed in dependence on an output signal from the controller. In the event that the second impedance element consists of a cross-magnetized inductor, this reference value may be in the form of a suitably adapted direct current supplied to the control winding of the inductor. In the event that the second impedance element comprises fixed inductors provided with short-circuit devices, as described with reference to FIG. 4A, these short-circuit devices may be activated, for example by choosing in a table of the relationship between reactance and activated short-circuit device(s).

When damping power oscillations, a signal representing oscillations in the active power in the transmission line is formed in some manner known to the person skilled in the art, and this signal, after suitable signal processing, is summed to the output signal from the above-mentioned controller.

The invention is not limited to the embodiments shown, but, of course, the person skilled in the art may modify it in a plurality of ways within the scope of the invention as defined in the claims. Thus, of course, the embodiment described with reference to FIG. 4A may be equipped with capacitors in a manner corresponding to the capacitors 23a, 23b and 23c in connection with the embodiment described with reference to FIG. 3A.

The capacitors may also be individually divided into a number of series-connected units, in which each unit is equipped with a controllable short-circuit device of a kind similar to that described with reference to FIG. 4A

As mentioned above, in the embodiment described with reference to FIG. 4A, the second impedance element 22a, 22b and 22c, respectively, may preferably be made with a larger number of mutually series-connected fixed inductors than what is shown in FIG. 4A.

The fixed reactance of the first impedance element may advantageously consist of a shunt inductor present in the transmission line.

1. A device (2) for control of power flow in a three-phase ac transmission line (L2, La, Lb, Lc), comprising for each of its phases (a, b, c) a transformer (12a, 12b, 12c) with a primary winding (121c) and a secondary winding (122c), the secondary winding being intended for serial connection into the respective phase of the transmission line, and the primary winding of the transformer being intended to be supplied with a voltage that is dependent on a controllable part of the voltage between the other two phases of the transmission line, characterized in that the device comprises, for each of the phases of the transmission line, a series circuit with a first (T1a, T1b, T1c) and a second (T2a, T2b, T2c) terminal and a connection point (Ja, Jb, Jc), the series circuit comprising a first reactive impedance element (21a, 21b, 21c) with a fixed reactance connected between the first terminal and the connection point, and a second reactive impedance element (22a, 22b, 22c, 23a, 23b, 23c) with a variable reactance connected between the connection point and the second terminal, wherein one of said terminals is coupled to the respective phase in the transmission line and the other of the terminals is coupled to a terminal at each of the other two series circuits, such that, for all the phases, either the first or the second terminal is coupled to the transmission line, and the primary winding is coupled between the connection points at the other two series circuits.

2. A device according to claim 1, characterized in that the second impedance element comprises a series circuit of an inductive (22a, 22b, 22c) and a capacitive (23a, 23b, 23c) reactance element.

3. A device according to any of claims 1 and 2, characterized in that the first impedance element comprises a first fixed inductor (21a, 21b, 21c), and that the second impedance element comprises a cross-magnetized inductor (22a, 22b, 22c) with a magnetic core, a main winding for alternating current, and a control winding for direct current, the control winding for control of a magnetic flux associated with the main winding by orthogonal magnetization of the magnetic core.

4. A device according to any of claims 1 and 2, characterized in that the first impedance element comprises a first fixed inductor (21a, 21b, 21c), and that the second impedance element comprises inductor equipment with a number of mutually series-connected fixed second inductors (221a, 221b, 221c, 223a, 223b, 223c), each of these being connected in parallel with a controllable short-circuit device (222a, 222b, 222c, 224a, 224b, 224c).

5. A device according to any of the preceding claims, wherein the transmission line has at least one conductor (La, Lb, Lc) per phase, characterized in that those of the terminals of the series circuits which are coupled to the respective phase of the transmission line are connected to said conductor(s) in the transmission line.

6. A device according to any of claims 1-4, wherein the secondary windings of the transformers are provided with centre taps (123a, 123b, 123c), characterized in that those of the terminals of the series circuits which are coupled to the respective phase of the transmission line are connected to said centre taps.

7. Use of a device according to any of the preceding claims for control of the distribution of power transmitted between parallel transmission lines (L1, L2) by coupling the device in one (L1) of the transmission lines.

8. Use of a device according to any of claims 1-6 for damping oscillations in active power between two power networks interconnected by means of a transmission line (L2) by coupling the device to the transmission line.

9. A method for control of power flow in a three-phase transmission line (L2, La, Lb, Lc), wherein said transmission line, for each of its phases (a, b, c), is serially supplied with an additional voltage (VSa, VSb, VSc), said additional voltage being generated in dependence on a controllable part of the voltage between the other two phases of the transmission line, characterized in that,
for each one of the phases of the transmission line, there is connected, to the respective phase, a series circuit with a first (T1a, T1b, T1c) and a second (T2a, T2b, T2c) terminal and a connection point (Ja, Jb, Jc), the series circuit comprising a first reactive impedance element (21a, 21b, 21c) with a fixed reactance connected between the first terminal and the connection point, and a second reactive impedance element (22a, 22b, 22c, 23a, 23b, 23c) with a controllable reactance connected between the connection point and the second terminal, whereby one of said terminals is coupled to the respective phase of the transmission line and the other terminal is coupled to a terminal at each one the two other two series circuits such that, for all the phases, either the first or the second terminal is coupled to the transmission line,
that for the respective phase the additional voltage is formed in dependence on the voltage between the connection points at the series circuits that are coupled to the other two phases, and
that the control of the power flow occurs by varying the reactances of the second impedance elements (22a, 22b, 22c, 23a, 23b, 23c).

10. A method according to claim 9, wherein the second impedance element comprises a series circuit of an inductive (22a, 22b, 22c) and a capacitive (23a, 23b, 23c) reactance element, characterized in that the inductive and capacitive elements are dimensioned in relation to each other such that the phase position for the additional voltage may be varied to lie both before and behind the phase position for the voltage of the transmission line in the respective phase such that the active power flow in the transmission line may be influenced both in an increasing and in a decreasing direction.

11. A method according to any of claims 9-10, wherein the first impedance element comprises a first fixed inductor (21a, 21b, 21c), and that the second impedance element comprises a cross-magnetized inductor (22a, 22b, 22c) with a magnetic core, a main winding for alternating current, and a control winding for direct current, characterized in that the reactance of the second impedance element is varied by controlling a magnetic flux associated with the main winding by orthogonal magnetization of the magnetic core in dependence on a direct current supplied to the control winding.

12. A method according to any of claims 9-10, wherein the first reactive impedance element comprises a first fixed inductor (21a, 21b, 21c), and that the second impedance element comprises inductor equipment with a number of mutually series-connected fixed second inductors (221a, 221b, 221c, 223a, 223b, 223c), each one of these being connected in parallel with a controllable short-circuit device (222a, 222b, 222c, 224a, 224b, 224c), characterized in that the reactance of the second impedance element is varied by respectively activating and deactivating the short-circuit devices.

13. A method according to any of claims 9-12, wherein the transmission line has at least one conductor (La, Lb, Lc) per phase, characterized in that those of the terminals of the series circuits that are coupled to the respective phase in the transmission line are connected to said conductors in the transmission line.

14. A method according to any of claims 9-12, wherein the additional voltage is serially applied to each phase in the transmission line by means of a secondary winding of a transformer, said secondary winding being provided with centre taps (123a, 123b, 123c), characterized in that those of the terminals of the series circuits that are coupled to the respective phase in the transmission line are connected to said centre taps.
